(19) United States
(12) Patent Application Publication
(10) Pub. No.: US 2019/0318344 A1
(43) Pub. Date: Oct. 17, 2019

(54) Systems and Methods for Use in Facilitating Enrollment Through Network Messaging

(71) Applicant: MASTERCARD INTERNATIONAL INCORPORATED, Purchase, NY (US)

(72) Inventors: Kent Olof Niklas Berntsson, New York, NY (US); Carrie Elizabeth Dweck, Suffern, NY (US); Kimberly Peyton, New York, NY (US)

(21) Appl. No.: 15/951,723

(22) Filed: Apr. 12, 2018

(51) Int. Cl. G06Q 20/36; G06Q 20/40

(52) U.S. Cl. CPC G06Q 20/3674; G06Q 20/401

(57) ABSTRACT

Systems and methods are provided for facilitating enrollment of consumers in programs associated with entities. One exemplary method includes soliciting, by at least one computing device, from a consumer, a payment account, in response to a request to enroll the consumer in a merchant account via a virtual wallet account associated with the consumer. The method further includes receiving an input indicative of the payment account and providing identifying information of the consumer to the merchant, at a virtual location of the merchant. The method also includes provisioning a payment account credential linked to the payment account to the merchant, for the merchant account, whereby the merchant is permitted to initiate a payment account transaction funded by the payment account in response to a purchase instruction from the consumer.

### FIELD

The present disclosure generally relates to systems and methods for use in facilitating enrollment through network messaging, and in particular, to systems and methods for use in providing information from one user account associated with a user to enroll another user account associated with the user, through network messaging.

### BACKGROUND

This section provides background information related to the present disclosure which is not necessarily prior art.

Consumers are known to purchase products (e.g., goods, services, etc.) from merchants. The purchases may be funded by the consumers through payment accounts, such as credit accounts, whereby the consumers present physical cards associated with the accounts to merchants to fund the transactions. Virtual devices are known to be used in addition, or in place of, physical cards in such transactions. When consumers purchase from merchants, through virtual locations (e.g., websites, etc.), merchants often invite the consumers to enroll in one or more accounts with the merchants, whereby subsequent purchases may be more efficient and/or easier. As part of enrollment, the consumers may be required to provide identifying information to the merchants, such as, for example, names, shipping addresses, billing addresses, phone numbers, etc. The merchants may then rely on this information to facilitate purchase transactions and, if necessary, shipment of the product(s) purchased to the consumers. The consumers then, optionally, may subsequently interact with the merchants through the enrolled accounts, whereby the consumers are not required to re-enter certain identifying information to complete subsequent transactions.

### DRAWINGS

The drawings described herein are for illustrative purposes only of selected embodiments and not all possible implementations, and are not intended to limit the scope of the present disclosure.

FIG. 1 illustrates an exemplary system of the present disclosure suitable for use in facilitating enrollment of consumers into merchant accounts, via virtual wallets associated with the consumers;

FIG. 2 is a block diagram of a computing device that may be used in the exemplary system of FIG. 1;

FIG. 3 is an exemplary method for use in facilitating enrollment of a consumer into a merchant account, via a virtual wallet associated with the consumer, and which may be implemented in the system of FIG. 1; and

FIGS. 4-6 are exemplary interfaces related to enrollment of a consumer into a merchant account and which may be displayed to the consumer in connection with the system of FIG. 1 and/or the method of FIG. 3.

Corresponding reference numerals indicate corresponding parts throughout the several views of the drawings.

### DETAILED DESCRIPTION

The description and specific examples included herein are intended for purposes of illustration only and are not intended to limit the scope of the present disclosure.

Merchants provide merchant accounts to consumers for a variety of reasons, including, for example, ease of transactions, communication (e.g., sending notifications, etc.), managing consumer relationships, etc. When a consumer enrolls in a merchant account, the consumer is often required to provide identifying information, and, occasionally, payment account information (e.g., a 16-digit primary account number (PAN), an expiration date for a payment device associated with the account, a card verification code (CVC), etc.) for use in performing payment account transactions with the merchant. However, providing this information may be time consuming and inconvenient. Uniquely, the systems and methods herein permit enrollment of consumers into merchant accounts via virtual wallets, whereby virtual wallet platforms provide information relied upon by merchants to enroll the consumers in the merchant accounts. In particular, when a consumer seeks to enroll in a merchant account associated with a merchant, the consumer opts to enroll with a virtual wallet, whereupon the merchant provides a request to a virtual wallet platform (e.g., via a virtual merchant location, etc.) to facilitate such enrollment. In turn, the virtual wallet platform verifies the consumer and then solicits certain information from the consumer (e.g., a selection of a payment account from the virtual wallet for use with the merchant account, etc.). The virtual wallet platform then provides identifying information for the consumer to the merchant, which, in turn, advances and/or completes enrollment of the consumer in the merchant account (using the information provided by the virtual wallet platform). When enrolled in the merchant account, the virtual wallet platform then, optionally, provisions a payment account credential associated with the payment account identified by the consumer, to the merchant, for use in payment account transactions by the consumer at the merchant. In this manner, the virtual wallet platform, which is the holder of consumer's identifying information, is leveraged to facilitate efficient and/or convenient enrollment of the consumer in the merchant account.

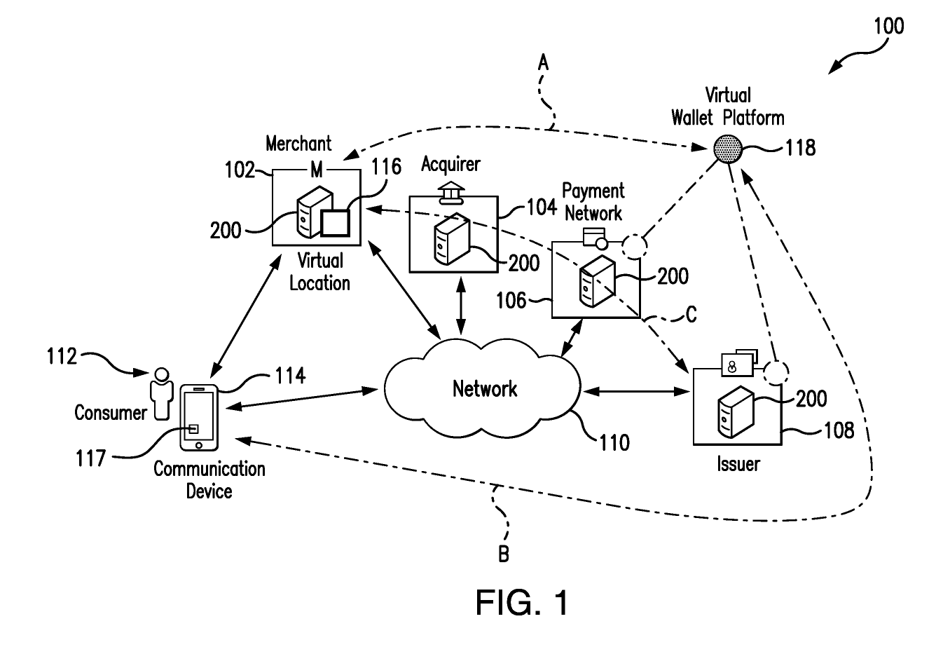

FIG. 1 illustrates an exemplary system 100, in which one or more aspects of the present disclosure may be implemented. Although the system 100 is presented in one arrangement, other embodiments may include systems arranged otherwise depending, for example, on types of merchants in the systems, types of loyalty programs used by the merchants, interactions between the merchants and virtual wallet applications and/or virtual wallet platforms, etc.

The illustrated system 100 generally includes a merchant 102, an acquirer 104 associated with accounts for the merchant 102, a payment network 106, and an issuer 108, each coupled to (and in communication with) network 110. The network 110 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network 110 may include multiple different networks, such as a private payment transaction network made accessible by the payment network 106 to the acquirer 104 and the issuer 108 and, separately, the public Internet, which is accessible as desired to the merchant 102, the acquirer 104, the payment network 106, the issuer 108, and/or consumer 112 (i.e., communication device 114 associated with the consumer 112, etc.).

In the illustrated embodiment, the merchant 102 includes a merchant account entity configured to manage consumer (and, potentially other) interactions with the merchant 102 (e.g., notifications, transactions, etc.). Consumers, optionally, may enroll into the merchant account entity, whereby products (e.g., goods, services, etc.) are offered for sale to the consumers by the merchant 102, including to the consumer 112. That said, the merchant 102 may include, for example, a retail membership store, a fitness club, a studio or business, a utility merchant (e.g., a gas merchant, a water provider, a power provider, a telecommunications provider, etc.), an entertainment merchant, an insurance merchant, or other desired merchant, etc. In general in the system 100, the merchant 102 is accessible to consumers via a merchant virtual location 116, such as, for example, a website, a network-based application, etc. As shown, the virtual location 116 may be included in the merchant, and in particular, at a computing device 200 of the merchant 102, or optionally, in other embodiments, the virtual location 116 may be provided and/or hosted from a computing device separated apart from the physical location of the merchant 102 (e.g., by a third party, etc.). Regardless, as used herein, the virtual location 116 and the merchant 102 are referred to interchangeably. In connection therewith, through the virtual location 116, multiple interfaces may be provided to the consumers (e.g., to consumer 112, etc.), via communication devices associated with the consumers (e.g., communication device 114 associated with the consumer 112, etc.), whereby the consumers may browse products, select products to shopping carts, for example, and/or purchase products from the merchant 102, etc.

The merchant 102 also offers merchant accounts to consumers, including to the consumer 112, whereby the consumers may use the merchant accounts to interact with the merchant 102 (e.g., purchase products, manage receipts, manage warranties, etc.), etc. And, in the illustrated system 100, the consumers may enroll in the merchant accounts through the virtual location 116. As part of the enrollment, the merchant 102 may solicit certain information about the consumers, including, without limitation, identifying information (e.g., names, addresses (e.g., shipping addresses, etc.), contact information (e.g., phone numbers, email addresses, etc.), etc.), payment credentials (e.g., stored credit card numbers (e.g., PANs, etc.), shipping preferences, loyalty account preferences, saved shopping lists, receipts, prior transactions, etc. To do so, the virtual location 116 is configured to provide one or more enrollment interfaces to the consumers, through which the merchant 102 is able to solicit and receive this information from the consumers. The enrollment often includes and/or is concluded by the establishment of login credentials for the consumers, whereby the consumers are then able to access their merchant accounts in the future. In general, once enrolled, the accounts facilitate interactions between the merchant 102 and consumers (e.g., the consumer 112, etc.) so that recurring and/or ongoing consumers are able to interact with the merchant 102 (and, often, the virtual location 116) in an efficient manner in such subsequent interactions.

Also in the system 100, the consumer 112 is associated with the communication device 114, which may include, without limitation, a smartphone, a laptop, a workstation, etc. The communication device 114 further includes a virtual wallet application 117 (or virtual wallet, electronic wallet, or e-wallet, etc.) therein and/or associated therewith. The virtual wallet application 117 is associated with and/or cooperates with a virtual wallet platform 118 (e.g., the MasterPass® wallet platform, etc.). The virtual wallet application 117 may be provided by the payment network 106, the issuer 108 (in connection with a payment account issued to the consumer 112 by the issuer 108), or another entity, etc. and may include, without limitation, MasterPass®, Apple Pay®, PayWave®, etc., or another suitable payment application as desired. In connection therewith, the consumer 112 is associated with the payment account issued by the issuer 108, and that payment account is provisioned to the virtual wallet application 117 included in the communication device 114 and is also known to the virtual wallet platform 118. In this manner, the virtual wallet platform 118 includes a virtual wallet account for the consumer 112, in which identifying information (as described above) is included in the virtual wallet platform 118 for the consumer 112, along with information for the consumer's payment account and, potentially, one or more other payment accounts associated with the consumer 112, etc.

In addition in the system 100, as indicated by the dotted lines and dotted circles in FIG. 1, the virtual wallet platform 118 may be incorporated with (in whole or in part) and/or hosted by the payment network 106 and/or the issuer 108. It should be appreciated, however, that the virtual wallet platform 118 may alternatively be standalone in the system 100, or incorporated elsewhere in the system 100, in other embodiments. Regardless, the virtual wallet platform 118 is particularly or specifically configured, by executable instructions, to uniquely operate as described herein. What's more, the virtual wallet platform 118, the merchant virtual location 116, and the communication device 114 are described herein as performing certain operations (i.e., as being configured to perform the operations). It should be appreciated that such operations may be performed by the virtual wallet platform 118, the virtual location 116, the communication device 114, and/or a combination and/or cooperation thereof.

In the illustrated embodiment, while only one merchant 102, one acquirer 104, one payment network 106, one issuer 108, one consumer 112 (and his/her associated communication device 114), and one virtual wallet platform 118 are illustrated in FIG. 1, it should be appreciated that a different number of these entities and devices (and their associated components) may be included in the system 100, or may be included as a part of other system embodiments, consistent with the present disclosure.

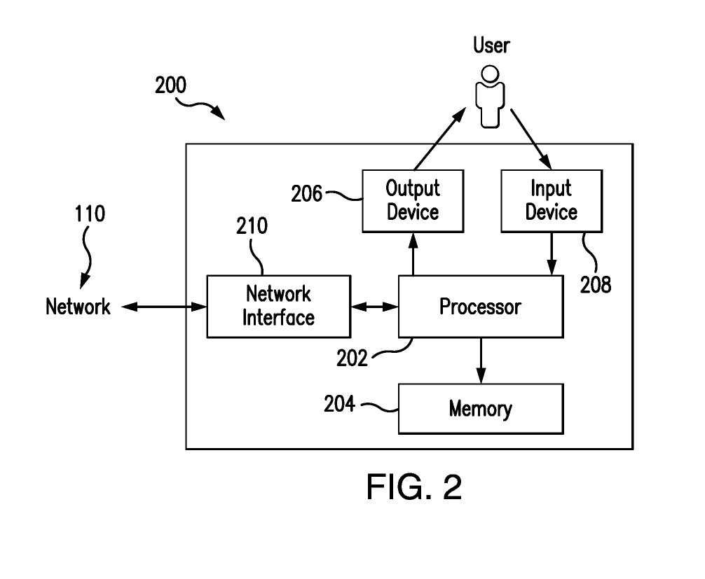

FIG. 2 illustrates an exemplary computing device 200 that may be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In the exemplary embodiment of FIG. 1, each of the merchant 102, the acquirer 104, the payment network 106, and the issuer 108 are illustrated as including, or being implemented in, computing device 200, coupled to the network 110. In addition, each of the communication device 114 associated with the consumer 112 and the virtual wallet platform 118 may be considered a computing device consistent with computing device 200. However, the system 100 should not be considered to be limited to the computing device 200, as described below, as different computing devices and/or arrangements of computing devices may be used. In addition, different components and/or arrangements of components may be used in other computing devices.

Referring to FIG. 2, the exemplary computing device 200 includes a processor 202 and a memory 204 coupled to the processor 202. The processor 202 may include one or more processing units (e.g., in a multi-core configuration, etc.). For example, the processor 202 may include, without limitation, one or more processing units (e.g., in a multi-core configuration, etc.), including a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, transaction data, personal identifying information, interfaces, accounts, payment account credentials, payment tokens, merchant identifiers, and/or other types of data suitable for use as described herein. Furthermore, in various embodiments, computer-executable instructions may be stored in the memory 204 for execution by the processor 202 to specifically cause the processor 202 to perform one or more of the unique functions described herein, such that the memory 204 is a physical, tangible, and non-transitory computer-readable storage media. Such instructions often improve the efficiencies and/or performance of the processor 202 as described herein in connection with performing the recited operations. It should be appreciated that the memory 204 may include a variety of different memories, each implemented in one or more of the functions or processes described herein.

In the exemplary embodiment, the computing device 200 includes an output device 206 that is coupled to the processor 202 (however, it should be appreciated that the computing device 200 could include output devices other than the output device 206, etc.). The output device 206 outputs information, electronic forms, etc. either visually or audibly to a user of the computing device 200, for example, the consumer 112, a user associated with the merchant 102, etc. In addition, it should be appreciated that various interfaces (as described herein) may be displayed at computing device 200, and in particular at output device 206, to display such information. The output device 206 may include, without limitation, a liquid crystal display (LCD), a light-emitting diode (LED) display, an organic LED (OLED) display, an “electronic ink” display, speakers, another computing device, etc. In some embodiments, the output device 206 may include multiple devices.

The computing device 200 also includes an input device 208 that receives inputs from the user (i.e., user inputs) such as, for example, acceptance of applications, selections to enroll with virtual wallets, confirmations to pay with virtual wallet applications, approvals of transactions, etc. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, may behave as both the output device 206 and the input device 208.

In addition, the illustrated computing device 200 also includes a network interface 210 coupled to the processor 202 and the memory 204. The network interface 210 may include, without limitation, a wired network adapter, a wireless network adapter, a mobile network adapter (e.g., an NFC adapter, a Bluetooth adapter, etc.), or other device capable of communicating to one or more different networks, including the network 110. Further, in some exemplary embodiments, the computing device 200 may include the processor 202 and one or more network interfaces incorporated into or with the processor 202.

Referring again to FIG. 1, in general in the system 100, when the consumer 112 interacts with the virtual location 116 of the merchant 102 (to purchase one or more products), the consumer 112 may opt to enroll in a merchant account associated with the merchant 102. In this exemplary embodiment, the consumer 112 has not yet enrolled with a merchant account at the merchant 102, and as such, when the consumer 112 accesses the merchant's virtual location 116, the consumer 112 is directed to enroll in a merchant account. The consumer 112 may enroll as is conventional by providing all necessary and/or desired information to the merchant 102. Or, as provided herein, the consumer 112 is also offered, in an interface associated with the virtual location 116, an option to “Enroll with Virtual Wallet.”

Then, when the consumer 112 selects the option to enroll with his/her virtual wallet, the virtual location 116 of the merchant 102 is configured to call an application programming interface (API) associated with the virtual wallet platform 118 (which is associated with managing the consumer's virtual wallet). In connection therewith, a request to enroll the consumer 112 via his/her virtual wallet is provided (along path A in FIG. 1) to the virtual wallet platform 118. The virtual wallet platform 118 is configured to receive the request. And, in response to the request, the virtual wallet platform 118 is configured to provide a login interface to the consumer 112, via path B in FIG. 1, at the communication device 114 (via the virtual location 116 of the merchant 102, for example), which solicits login credentials from the consumer 112 for his/her virtual wallet. In response to valid credentials at the interface, the virtual wallet platform 118 is configured to solicit identification of at least one payment account from the consumer 112, via the interface or via at least one additional interface, for use with the merchant account. In response, the consumer 112 selects and/or inputs the identification of the desired payment account (e.g., by PAN (in whole or in part), by selection of a particular payment account option, etc.), and the virtual wallet platform 118 is configured to receive the identification of the payment account. In addition to the identification of the payment account, the virtual wallet platform 118 may be configured to solicit and receive further identification of the payment account from the consumer 112 through additional information, such as, for example, a billing address, an expiration date, an issuer identification, etc.

In addition to the identification of the payment account, the virtual wallet platform 118 is also configured to solicit and receive (from the consumer 112) (through one or more interfaces) one or more consumer preferences for identifying information related to the consumer 112. Specifically, for example, identifying information included in the virtual wallet account for the consumer 112 may include duplicate, conflicted or different information for the consumer 112 (e.g., multiple different shipping address, etc.). As such, the virtual wallet platform 118 may be configured to solicit a selection, from the consumer 112, of the particular identifying information to provide to the merchant 102 for the merchant account. In other embodiments, the consumer preferences may be related to payment account preferences (e.g., related to recurring payments, etc.) and/or limitations of identifying information to be provided to the merchant 102 (e.g., prohibit sharing of a social security number, etc.). And, also, the virtual wallet platform 118 may be configured to provide, via one or more interfaces, terms and conditions associated with the virtual wallet platform 118, the issuer 108, the merchant 102, etc. for review by the consumer 112 The virtual wallet platform 118 may then be configured to receive and store the consumer's responses and acceptance (or decline) of the terms and conditions in memory associated therewith. It should be appreciated that the virtual wallet platform 118 may be configured to solicit any information to be used in connection with the merchant account, or otherwise, so that a complete enrollment of the consumer 112 to the merchant account by the merchant 102 is able to be achieved. In at least one embodiment, for example, the virtual wallet platform 118 may be configured to further solicit login credentials from the consumer 112, which are specific and/or usable by the consumer 112 to subsequently access the merchant account for the consumer 112, at the virtual location 116 associated with the merchant 102, when enrollment is complete.

Further in the system 100, the virtual wallet platform 118 is configured to next provide identifying information for the consumer 112 to the merchant 102 to facilitate the enrollment of the consumer 112 in the merchant account with the merchant 102 (e.g., along path A, etc.). In response to the identifying information, the virtual location 116 of the merchant 102 is configured to store the identifying information in association with a merchant account for the consumer 112 (e.g., in memory of the computing device 200 at the merchant 102, etc.), to determine if additional information about the consumer 112 is needed and/or desired, and, if any is needed and/or desired, to solicit such needed and/or desired information from the consumer 112 through one or more interfaces. What's more, if not done so by the virtual wallet platform 118, the virtual location 116 of the merchant 102 may be configured to solicit a username and password, broadly login credentials, from the consumer 112 to be associated with the consumer's merchant account and usable by the consumer 112 to access the merchant account, at the virtual location 116, when enrollment is complete. The virtual location 116 of the merchant 102 is configured to then enroll the consumer 112 in the merchant account and to provide an indicator of the enrollment to the virtual wallet platform 118.

In response to the enrollment indicator, the virtual wallet platform 118 is configured to generate a payment account credential (e.g., a token, etc.) for the consumer 112, which is linked to the payment account identified by the consumer 112 for use in the merchant account, and to provision the payment account credential to the merchant 102 and, specifically, to the merchant account for the consumer 112. The virtual location 116 of the merchant 102 is configured to, in turn, store the payment account credential in association with the merchant account for the consumer 112 (e.g., in the memory of the computing device 200 at the merchant 102, etc.). In this manner, the consumer 112 may subsequently utilize the payment account to purchase products at the merchant 102, and/or the merchant 102 may initiate payment account transactions to the payment account for fees, charges, bills, and/or dues associated with the merchant account (e.g., upon approval by the consumer 112 at enrollment or thereafter, etc.). In addition, the payment account credential may further be provisioned and/or included in the virtual wallet of the consumer 112, whereby the consumer 112 may be permitted to utilize controls associated with the payment account credential (e.g., suspend controls, delete controls, spending limit controls, etc.) for the merchant account and/or manage the merchant account via the virtual wallet application 117, etc.

With continued reference to FIG. 1, as needed, the acquirer 104, the payment network 106 and the issuer 108 (broadly, transacting institutions, etc.) cooperate to authorize, clear and settle a transaction between the merchant 102 and the consumer 112 for one or more products (e.g., via the merchant's virtual location 116 or in person, etc.), funded by the consumer's payment account. In one exemplary transaction, to facilitate the transaction with the consumer 112, the merchant 102 compiles and transmits an authorization request for the transaction, at the request of the consumer 112 or based on a preauthorized fee, charge, etc. being due to the merchant 102. The authorization request may include, for example, the PAN for the consumer's payment account (or other payment account credential, such as the token, etc.) and an amount of the transaction, etc.

In turn, the authorization request is transmitted by the merchant 102, for example, to the acquirer 104 (via the network 110). The acquirer 104, then, communicates the authorization request with the issuer 108 through the payment network 106 (via the network 110), for authorization of the transaction (generally along path C in FIG. 1). In response, the issuer 108 determines if the consumer's payment account is in good standing and/or if sufficient credit/funds exist in the associated payment account to fund the transaction. In this example, if the issuer 108 approves/declines the transaction, an authorization reply is provided by the issuer 108 back to the merchant 102 authorizing the transaction. When approved, the merchant 102 is then able to proceed in the transaction, by, for example, instructing delivery of the product(s) to the consumer 112. The transaction is later cleared and settled by and between the merchant 102 and the acquirer 104 (in accordance with a settlement arrangement, etc.), and by and between the acquirer 104 and the issuer 108 (in accordance with another settlement arrangement, etc.).

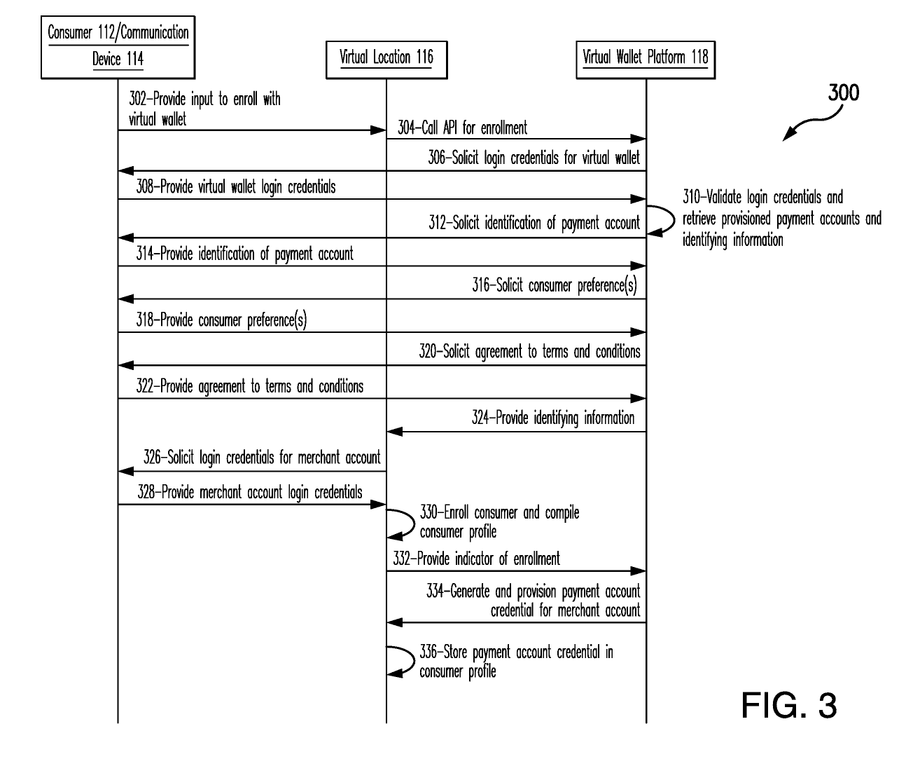

FIG. 3 illustrates an exemplary method 300 for facilitating enrollment of a consumer in a merchant account associated with a merchant. The exemplary method 300 is described as implemented in the merchant 102, the wallet application 117 associated with the consumer 112, and the virtual wallet platform 118 of the system 100, and also with reference to the computing device 200. However, it should be understood that the methods herein are not limited to the exemplary system 100 or the exemplary computing device 200 Likewise, the systems and the computing devices herein should not be understood to be limited to the exemplary method 300.

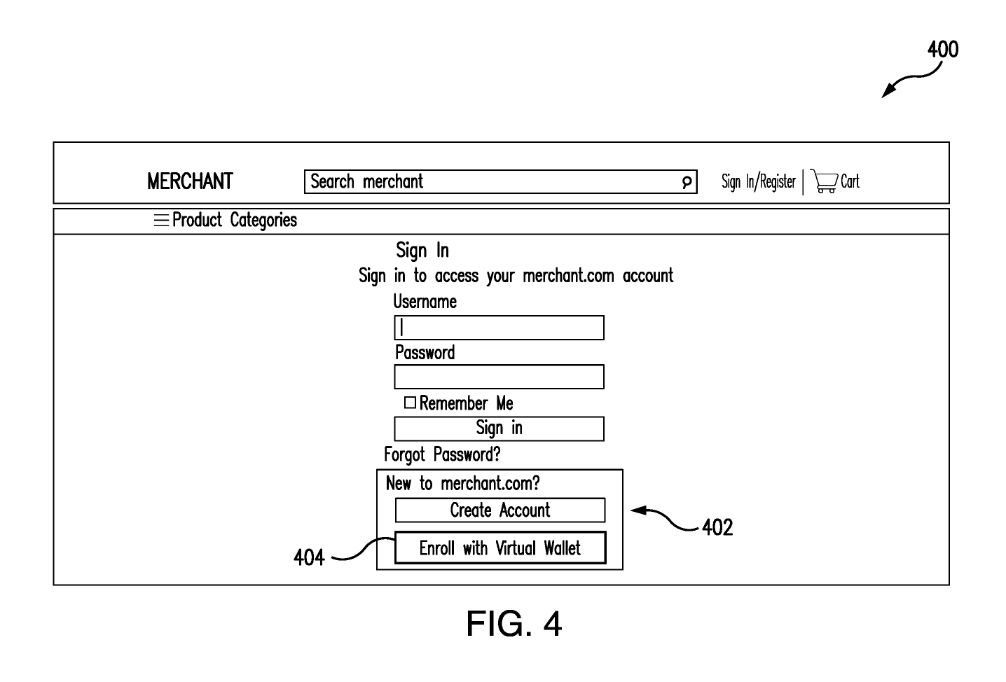

The method 300 is also described with reference to exemplary interfaces 400-600 included in FIGS. 4-6, which may be presented to the consumer 112 as part of enrolling for a merchant account from the merchant 102. The exemplary interfaces 400-600, however, are provided for purposes of illustration only, and thus, should not be understood to the limit the present disclosure (as other interfaces with other content and/or formats may be used in other embodiments).

In connection therewith, the consumer 112 initially accesses the virtual location 116 of the merchant 102 with the intent to purchase one or more products, whereby enrollment into a merchant account is provided as an option, required and/or desired. In the following example, the consumer 112 is not yet enrolled in such a merchant account with the merchant 102 and elects to enroll in a merchant account. In response, the virtual location 116 provides an exemplary merchant account access interface 400, as shown in FIG. 4, to the consumer 112 at the communication device 114.

In the interface 400, the consumer 112 is provided options 402 to either enroll for a merchant account through the merchant's virtual location 116, as is conventional, or to uniquely enroll through use of the consumer's virtual wallet. Here, the consumer 112 provides an input, at 302 in the method 300, to enroll for the merchant account using the virtual wallet, for example, by selecting the button 404, titled “Enroll with Virtual Wallet.” In response to the selection, the virtual location 116 of the merchant (e.g., via integration and/or communication with the virtual wallet platform 118, etc.) determines if a default virtual wallet is selected for the consumer 112 (e.g., the consumer 112 may be directed to a last used or preferred virtual wallet via a cookie in the web browser at the consumer's communication device 114 through which the virtual location 116 is being accessed (if the consumer 112 is already enrolled with the virtual wallet platform 118 and has a virtual wallet), etc.). If no default virtual wallet is defined, the virtual location 116 may offer the consumer 112 the option to select the virtual wallet and/or to otherwise identify the virtual wallet for use in enrollment in the merchant account, or newly enroll for a virtual wallet (if the consumer 112 is a new customer to the wallet platform 118). In particular in this later scenario, for example, the consumer 112 may be directed to enter an email address or phone number to be routed to the appropriate virtual wallet (if already enrolled with the wallet platform 118) but not recognized, or the consumer 112 may be invited to enroll in a virtual wallet product (as is generally conventional). In this example, the virtual wallet associated with the consumer's payment account is a default virtual wallet within the communication device 114, whereby no further selection of the virtual wallet (or enrollment of the consumer 112 for such a virtual wallet) is necessary (although, the consumer 112 may optionally opt to identify a different, non-default virtual wallet in some embodiments, even when a default virtual wallet is defined).

In response to the input from the consumer 112 to enroll for the merchant account using his/her virtual wallet, the virtual location 116 of the merchant 102 calls, at 304 in the method 300, an API associated with the virtual wallet platform 118, thereby requesting enrollment of the consumer 112 in the merchant account via the virtual wallet platform 118. The API call, optionally, for example, may include, beyond the request to enroll, a listing of the particular identifying information which the merchant 102 needs, requires or desires to enroll the consumer 112 in the merchant account.

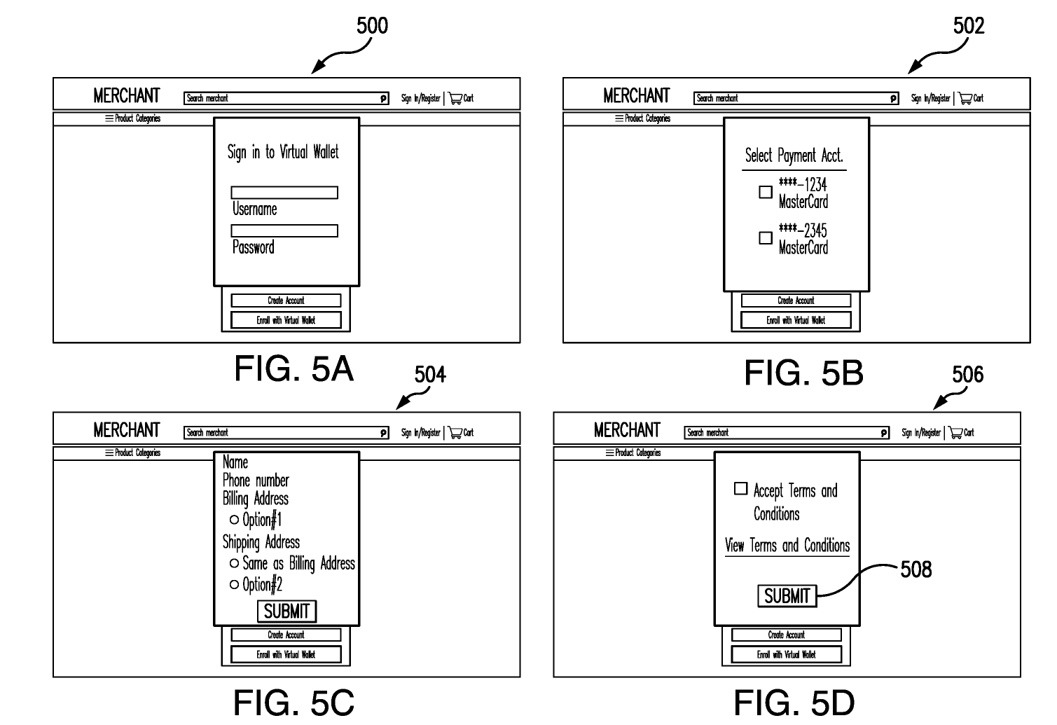

In turn, the virtual wallet platform 118 solicits, at 306, login credentials for the virtual wallet account of the consumer 112, through an interface at the communication device 114 (e.g., as a condition prior to performing subsequent operations in the method 300 in order to authenticate the consumer 112, etc.). For example, as shown in FIG. 5A, an exemplary interface 500 may be displayed to the consumer 112 (on top of interface 400 displayed to the consumer at the merchant's virtual location 116) that solicits the consumer 112 to provide virtual wallet login credentials, so that the virtual wallet platform 118 is able to verify and/or authenticate the consumer 112. The consumer 112 then provides the login credentials for the virtual wallet, at 308 in the method 300, through the interface 500, for example. At 310, upon receipt of the login credentials, the virtual wallet platform 118 validates the login credentials and, when validated, retrieves provisioned payment account and identifying information for the consumer 112, which is associated with and/or included in the consumer's virtual wallet account.

The virtual wallet platform 118 then solicits identification of a payment account, at 312, from the consumer 112 for use with the merchant account. For example, the virtual wallet platform 118 may compile (and cause to be displayed to the consumer 112, again on top of the interface 400 displayed to the consumer 112 at the merchant's virtual location 116) an interface such as the exemplary interface 502, shown in FIG. 5B, identifying each of the payment accounts provisioned to the virtual wallet account for the consumer 112. As shown, in the interface 502, the virtual wallet account is provisioned with two payment accounts, each of which is a MasterCard® account: one having a PAN ending in 1234 and the other having a PAN ending in 2345. At the interface 502, the consumer 112 selects one of the two payment accounts, thereby providing an exemplary identification of the payment account selected, at 314 in the method 300. It should be appreciated that the virtual wallet platform 118 may otherwise solicit identification of a payment account from the consumer 112, and the consumer 112 may otherwise provide the identification of the payment account (e.g., by means other than selecting a payment account from a predetermined list, such as by manually entering a PAN for a payment account, etc.; etc.).

In addition in the method 300, the virtual wallet platform 118 solicits one or more consumer preferences from the consumer 112, at 316. In doing so, the virtual wallet platform 118 may provide certain identifying information of the consumer 112, such as, for example, a name, an address(es), contact information (e.g., a phone number, an email address, etc.) etc., and a request that the consumer 112 verify the information and/or select from among the information (i.e., consumer preferences). As shown in FIG. 5C, for example, the virtual wallet platform 118 may provide an exemplary interface 504 to the communication device 114 (and cause it to be displayed to the consumer 112, again on top of the interface 400 displayed to the consumer 112 at the merchant's virtual location 116), which includes certain identifying information, and further solicits the selection of a shipping address from the multiple addresses included in the identifying information for the consumer 112 (and associated with the consumer's virtual wallet account). In response, the consumer 112 provides the consumer preference(s), at 318 in the method 300 (e.g., including a selection of one of the shipping addresses in the interface 504, etc.).

Further in the method 300, the virtual wallet platform 118 solicits, at 320, agreement of the consumer 112 to terms and conditions associated with the merchant account and/or enrollment in the merchant account through the virtual wallet platform 118. As an example, FIG. 5D illustrates an interface 506, which may be displayed to the consumer 112, again on top of the interface 400 displayed to the consumer 112 at the merchant's virtual location 116, and used to solicit agreement with terms and conditions. In response, in the interface 506, the consumer 112 is able to agree to the terms and conditions by selecting the submit button 508. In this way, the consumers 112 provide, at 322 in the method 300, agreement to the terms and conditions.

In connection with the above, the virtual wallet platform 118 determines identifying information to be provided to the merchant 102 and provides, at 324, the identifying information to the merchant 102, and specifically, to the virtual location 116 of the merchant 102. For example, the virtual wallet platform 118 may identify particular information required by the merchant 102 for enrolling the consumer 112 in the merchant account (e.g., based on predetermined information for the given merchant account, based on information pre-specified by the merchant 102, based on the identifying information indicated in the API call from the virtual location 116 (at 304), based on consumer preferences at the consumer's virtual wallet account and information approved/authorized by the consumer 112 to be shared, etc.

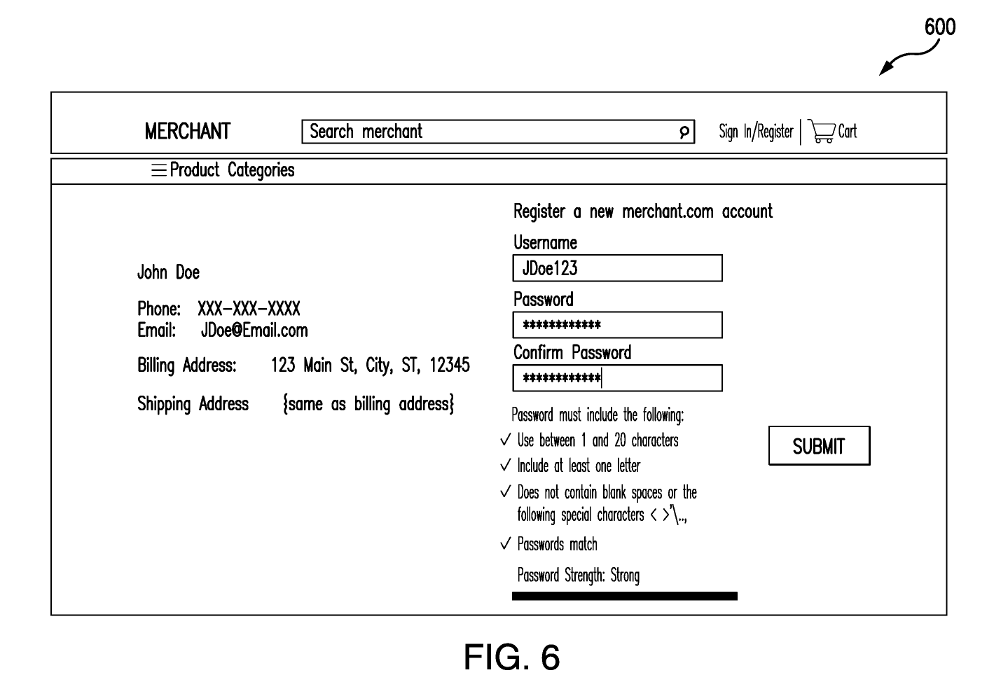

Upon receipt of the identifying information, the virtual location 116 of the merchant 102, or more generally, the merchant 102, solicits, at 326, login credentials for the merchant account from the consumer 112. For example, as illustrated in FIG. 6, the virtual location 116 may provide an interface 600 to the communication device 114, to be displayed to the consumer 112, which includes the identifying information received from the virtual wallet platform 118, in whole or in part, for review by the consumer 112. In this manner, the consumer 112 is able to view and verify the identifying information. In addition, as shown in FIG. 6, the interface 600 includes a request for the consumer 112 to create login credentials for the merchant account, which may be, in general, any credentials not already used for a different merchant account. It should be understand that minimum credential characteristics may be required, with related rules enforced by the virtual location 116. The consumer 112 then provides the new login credentials for the merchant account, at 328 in the method 300.

With the merchant account login credentials, the virtual location 116 of the merchant 102, or more generally, the merchant 102, enrolls the consumer 112 in a merchant account and compiles a consumer profile for the consumer 112, at 330 in the method 300. The consumer profile may include, for example, a merchant account number, the merchant account login credentials for the consumer 112, the identifying information (in whole or in part) for the consumer 112, etc. In addition, the virtual location 116, and more generally, the merchant 102, provides an enrollment indicator to the virtual wallet platform 118 (e.g., via the API, etc.), at 332. Upon receipt, the virtual wallet platform 118 generates and provisions to the virtual location 116, at 334, a payment account credential associated with the payment account which was identified by the consumer 112 for use with the merchant account (e.g., at interface 502 of FIG. 5B, etc.). The payment account credential may include, for example, a token, which is linked to the identified payment account (e.g., associated with and/or stored in combination with the consumer's payment account in memory at the virtual wallet platform 118, etc.). When provisioned, the virtual location 116 of the merchant 102, and more generally, the merchant 102, stores, at 336, the payment account credential in the consumer profile for the consumer 112 and/or the merchant account. In addition, the virtual wallet platform 118 provides the payment account credential to the virtual wallet account of the consumer 112, whereby the payment account credential is populated into the virtual wallet of the consumer 112 at the communication device 114 (e.g., at the virtual wallet application 117, etc.). In connection therewith the consumer 112 is able to control his/her payment account credentials (e.g., delete credentials, suspend credentials, etc.), as desired. In some embodiments, the virtual wallet platform 118 generates and provisions to the virtual location 116 (at 334) the payment account credential associated with the payment account only after the indicator of enrollment of the consumer 112 is received.

From time to time, as required or desired, the payment account credential provisioned to the consumer's merchant account may then be used, by the merchant 102 or the consumer 112, to facilitate the funding of payment account transactions at the merchant 102, for the consumer 112, through the identified payment account. For example, the merchant 102 may initiate a payment account transaction for monthly dues, using the token, for example. In another example, the consumer 112 may rely on the token, for example, to purchase products from the merchant 102, through the virtual location 116 (upon accessing his/her merchant account with the merchant account login credentials), etc.

In view of the above, the systems and methods herein permit consumers to utilize virtual wallets to provide identifying information to merchants, through virtual locations, for use in enrolling the consumers associated with the virtual wallets in desired merchant accounts for the merchants. As such, the identifying information is provided directly from a virtual wallet platform associated with the virtual wallets to the merchants, to limit the inconvenience of the consumers having to enter the identifying information and further permitting the virtual wallet platform to directly provision payment account credentials associated with selected payment accounts of the consumers. In this manner, the complete enrollment of the consumers in the merchant accounts, with the ability to facilitate transactions, at the direction of the consumers and/or the merchants, is provided.

Again and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) in response to a request to enroll a consumer to a merchant account using a virtual wallet account associated with the consumer, soliciting, by at least one computing device, from the consumer, a payment account to be associated with the merchant account; (b) receiving, by the at least one computing device, an input indicative of the payment account; (c) providing, by the at least one computing device, identifying information of the consumer to the merchant, at the virtual location associated with the merchant, in connection with enrollment of the consumer in the merchant account, the identifying information including at least one of: a name of the consumer, an address for the consumer, and contact information for the consumer; and (d) provisioning, by the at least one computing device, to the merchant at the virtual location associated with the merchant, a payment account credential linked to the payment account indicated by the consumer, for association with the merchant account, whereby the merchant is permitted to initiate a payment account transaction funded by the payment account, as identified in the merchant account, in response to a purchase instruction from the consumer.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” “coupled to,” “associated with,” “included with,” or “in communication with” another element or layer, it may be directly on, engaged, connected or coupled to, associated with, or in communication with the other element or layer, or intervening elements or layers may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

In addition, as used herein, a product may include a good, a service, etc.

None of the elements/features recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in facilitating enrollment of a consumer in a merchant account of a merchant, via a virtual location associated with the merchant, the system comprising at least one virtual wallet platform computing device configured to:
receive a request, from a virtual location associated with a merchant, to enroll a consumer in a merchant account of the merchant via a virtual wallet account associated with the consumer;
solicit, from the consumer, identification of a payment account to be associated with the merchant account and at least one consumer preference for the merchant account;
receive the identification of the payment account and the at least one consumer preference from the consumer;
provide identifying information for the consumer to the merchant, at the virtual location, based on the at least one consumer preference, the identifying information including at least one of: a name of the consumer, an address of the consumer, and contact information for the consumer; and
provision a payment account credential to the merchant account at the merchant, the payment account credential linked to the payment account identified by the consumer, whereby the merchant is permitted to initiate a payment account transaction funded by the payment account in response to a purchase instruction from the consumer via the merchant account.

2. The system of claim 1, wherein the at least one virtual wallet platform computing device is further configured to:
solicit, from the consumer, agreement to terms and conditions, via an application programming interface (API); and
receive acceptance to the terms and conditions prior to providing the identifying information for the consumer to the merchant.

3. The system of claim 1, wherein the identifying information for the consumer includes the name of the consumer and a shipping address identified by the consumer; and
wherein the at least one virtual wallet platform computing device is configured to provide the at least one consumer preference to the consumer, to be selected by the consumer in order to solicit the at least one consumer preference.

4. The system of claim 1, wherein the at least one virtual wallet platform computing device is further configured to authenticate the consumer, via a login credential associated with the virtual wallet account associated with the consumer, prior to soliciting identification of the payment account from the consumer.

5. The system of claim 1, wherein the payment account credential includes a payment token; and
wherein the at least one virtual wallet platform computing device is further configured to generate the payment token prior to provisioning the payment token to the merchant account.

6. The system of claim 5, wherein the identifying information includes a billing address of the payment account.

7. The system of claim 5, wherein the at least one virtual wallet platform computing device is configured to receive, from the merchant, an indication of an enrolled merchant account, via an application programming interface (API), in response to providing the identifying information for the consumer to the merchant, prior to provisioning the payment account credential to the merchant account.

8. The system of claim 1, wherein the at least one virtual wallet platform computing device is further configured to provision the payment account credential to the virtual wallet account associated with the consumer, whereby the consumer is permitted to manage the payment account credential via the virtual wallet account.

9. A computer-implemented method for use in facilitating enrollment of a consumer in a merchant account specific to a merchant, via a virtual location associated with the merchant, the method comprising:
in response to a request to enroll a consumer to a merchant account using a virtual wallet account associated with the consumer, soliciting, by at least one computing device, from the consumer, a payment account to be associated with the merchant account;
receiving, by the at least one computing device, an input indicative of the payment account;
providing, by the at least one computing device, identifying information of the consumer to the merchant, at a virtual location associated with the merchant, in connection with enrollment of the consumer in the merchant account, the identifying information including at least one of: a name of the consumer, an address for the consumer, and contact information for the consumer; and
provisioning, by the at least one computing device, to the merchant at the virtual location associated with the merchant, a payment account credential linked to the payment account indicated by the consumer, for association with the merchant account, whereby the merchant is permitted to initiate a payment account transaction funded by the payment account, as identified in the merchant account, in response to a purchase instruction from the consumer.

10. The computer-implemented method of claim 9, further comprising:
soliciting, from the consumer, at least one consumer preference for the merchant account; and
receiving, at the at least one computing device, the at least one consumer preference from the consumer;
wherein providing the identifying information of the consumer to the merchant includes providing the identifying information of the consumer to the merchant consistent with the at least one consumer preference.

11. The computer-implemented method of claim 9, further comprising soliciting, by the at least one computing device, from the consumer, login credentials for the virtual wallet account prior to providing the identifying information of the consumer to the merchant and prior to provisioning the payment account credential to the merchant.

12. The computer-implemented method of claim 11, further comprising:
receiving, at the at least one computing device, the solicited login credentials from the consumer; and
retrieving, by the at least one computing device, the identifying information of the consumer from memory associated with the at least one computing device when the received login credentials are validated.

13. The computer-implemented method of claim 9, further comprising generating, by the at least one computing device, the payment account credential and linking the payment account credential to the payment account indicated by the consumer.

14. The computer-implemented method of claim 13, further comprising receiving, at the at least one computing device, an enrollment indicator from the merchant, via the virtual location of the merchant, indicating that the consumer is enrolled to the merchant account;
wherein generating the payment account credential and provisioning the payment account credential to the merchant includes generating the payment account credential and provisioning the payment account credential to the merchant in response to receiving the enrollment indicator.

15. The computer-implemented method of claim 14, further comprising:
soliciting, by the at least one computing device, from the consumer, agreement to terms and conditions associated with the merchant account, via an application programming interface (API); and
receiving, at the at least one computing device, acceptance to the terms and conditions prior to providing the identifying information of the consumer to the merchant.

16. The computer-implemented method of claim 14, further comprising provisioning the payment account credential to the virtual wallet account associated with the consumer, whereby the consumer is permitted to manage the payment account credential via the virtual wallet account.

17. A non-transitory computer-readable storage media including executable instructions facilitating enrollment of a consumer in a merchant account specific to a merchant, via a virtual location associated with the merchant, which, when executed by at least one processor, cause the at least one processor to:
receive a request, from a virtual location associated with a merchant, to enroll a consumer in a merchant account of the merchant via a virtual wallet account associated with the consumer;
in response to the request, authenticate the consumer, via a login credential for with the virtual wallet account associated with the consumer; and
when the consumer is validated:
solicit from the consumer a payment account to be associated with the merchant account via an interface including the at least one payment account as an option for the consumer; and
provide identifying information of the consumer to the merchant, at the virtual location associated with the merchant, for use by the merchant to enroll the consumer in the merchant account, the identifying information including at least one of: a name of the consumer, an address for the consumer, and contact information for the consumer;
receive, from the merchant, an enrollment indicator from the merchant, via the virtual location of the merchant, indicating that the consumer is enrolled to the merchant account; and
upon receipt of the enrollment indicator:
generate a payment account credential linked to the payment account indicated by the consumer; and
provision the payment account credential to the merchant at the virtual location associated with the merchant for association with the merchant account, whereby the merchant is permitted to initiate a payment account transaction funded by the payment account, as identified in the merchant account, in response to a purchase instruction from the consumer.

18. The non-transitory computer-readable storage media of claim 17, wherein the executable instructions, when executed by the at least one processor, further cause the at least one processor to:
solicit, from the consumer, agreement to terms and conditions associated with the merchant account, via an application programming interface (API); and
receive acceptance to the terms and conditions prior to providing the identifying information of the consumer to the merchant.

19. The non-transitory computer-readable storage media of claim 17, wherein the executable instructions, when executed by the at least one processor, further cause the at least one processor to provision the payment account credential to the virtual wallet account associated with the consumer, whereby the consumer is permitted to manage the payment account credential via the virtual wallet account.
